(19) United States
(12) Patent Application Publication
(10) Pub. No.: US 2004/0099253 A1
(43) Pub. Date: May 27, 2004

(54) Carbon-containing shaped cylinders for engine air induction system emission reduction

(76) Inventor: Michael Ford Tschantz, Lexington, VA (US)

Correspondence Address: MEADWESTVACO CORPORATION, 5255 VIRGINIA AVENUE, P.O. BOX 118005, CHARLESTON, SC, 29423-8005, US

(21) Appl. No.: 10/621,946

(22) Filed: Jul. 15, 2003

Related U.S. Application Data
(60) Provisional application No. 60/416,974, filed on Oct. 8, 2002.

(51) Int. Cl. F02M 33/04

(52) U.S. Cl. 123/518

(57) ABSTRACT

The subject matter of the invention described and claimed herein is disclosed as a vapor-containing element for adding to the ductwork, or the inside walls of the AIS ductwork, which element preferably is shaped to conform to the shape of said ductwork, with the material forming the walls of the element. The open inside of the cylindrical component would allow air to pass through the element unobstructed, with little pressure drop.

This application claims the benefit of U.S. Provisional Application No. 60/416,974 filed on Oct. 8, 2002.

### BACKGROUND OF THE INVENTION

1. Field of the Invention

This invention relates to a method for reducing emissions from automotive evaporative control systems using adsorbing canisters to remove volatile organic compounds, and other chemical agents from fluid streams. More particularly, this invention relates to using vapor-adsorbing materials in hydrocarbon fuel consuming engines. Most particularly, the invention relates to using vapor adsorbing material to remove volatile organic compounds from automotive air induction systems (AIS).

2. Description of Related Art (Including Information Disclosed Under 37 CFR 1.97 and 37 CFR 1.98)

Evaporation of gasoline from motor vehicle fuel systems is a major potential source of hydrocarbon air pollution. The automotive industry is challenged to design engine components and systems to contain, as much as possible, the almost one billion gallons of gasoline evaporated from fuel systems each year in the United States alone. Stricter regulations governing automotive evaporative emissions are requiring automotive manufacturers to take steps to control hydrocarbon losses through the engine air induction systems (AIS). Sources for hydrocarbons include unburnt fuel injected during the engine shutoff sequence, leaking fuel injectors, blow-by gases in the crankcase, and dissolved fuel in the engine oil among others. The mechanisms by which hydrocarbons escape into the environment include diffusion and natural convection from engine components through the airduct into the atmosphere and through leaks in engine and ductwork components. Automotive manufacturers are looking for low-cost solutions to auto emission control that will not significantly adversely affect engine performance. Although improvements are being made to decrease the magnitude of hydrocarbons made available to escape from the engine into the environment, it is likely a significant source will remain and will require control for some vehicles.

The general philosophy for controlling engine evaporative emissions includes: (1) using an adsorbent such as activated carbon or zeolite to adsorb the hydrocarbons while the engine is turned off, preventing the majority of the hydrocarbons from migrating past the adsorbent, and desorbing the hydrocarbons for burning in the engine while the engine is running by purging with engine air, and (2) using the geometry of the ductwork to reduce the rate by which hydrocarbons may migrate.

Existing adsorbent technologies include: (1) activated carbon containing honeycombs, (2) zeolite containing honeycombs, (3) activated carbon containing pleated thin beds, and (4) activated carbon containing panels, among others. These technologies all perform well for effectively trapping and purging hydrocarbons, but all create additional, significant pressure drop in the AIS, causing the engine to work harder to achieve the same air throughput. The increased pressure drop leads to a decrease in engine horsepower due to the added workload required to move air through the AIS. Honeycombs can add up to 4″ water column (w.c.) or more of pressure drop under typical conditions. Panel types of filters could add 0.5″ w.c. or more of pressure loss. The present invention discloses a means by which hydrocarbons may be effectively trapped and purged while creating significantly less pressure drop in the AIS.

### SUMMARY OF THE INVENTION

The subject matter of the invention described and claimed herein is disclosed as a vapor-containing article for adding to the ductwork or AIS components (e.g., resonators, airbox, etc.), or the inside walls of the AIS ductwork, which element preferably is shaped to conform to the shape of said ductwork, with the material forming the walls of the article. The inside of the cylindrical component would remain open, allowing air to pass through the article unobstructed, with little (1″ w.c.) to no added pressure drop. The article is comprised of both an adsorbent material component and a support component.

The adsorbent could also coat the inside of the ductwork or AIS components where the support component was the ductwork itself. The adsorbing material could also be a partition running through the duct, designed also not to add significant pressure losses.

### BRIEF DESCRIPTION OF THE DRAWING(S)

FIG. 1a is a perspective view of an embodiment of the invention article.

FIG. 1b is a perspective view of an embodiment of the invention article.

FIG. 1c is a perspective view of an embodiment of the invention article.

FIG. 1d is a perspective view of an embodiment of the invention article.

FIG. 2 shows the design of the testing fixture used to quantify emissions for the invention vapor-containing hollow emission control elements.

FIG. 3 is a graphical representation of the correlation of the diameter to length ratio of the invention element and its performance in emission control.

FIG. 4 shows the design of the testing fixture used to quantify emissions for the invention vapor adsorbent rigid hollow cylinder and pliable adsorbent sheet material.

FIG. 5 is a graphical representation of predicted emissions for 2.25″ I.D.×5″ L rigid and pliable sheet adsorbent cylinders produced using the testing device of FIG. 4.

### DESCRIPTION OF THE PREFERRED EMBODIMENT(S)

The benefits of the invention arise from an understanding of the general inside diameter to length requirements necessary to effectively control diffusional and convective evaporative emissions in a low pressure drop configuration. Benefits also are derived from the invention design strategies to increase or decrease purge rates by allowing air to pass on one or both sides of the shaped article, as well as by controlling bed thickness of the adsorbing material.

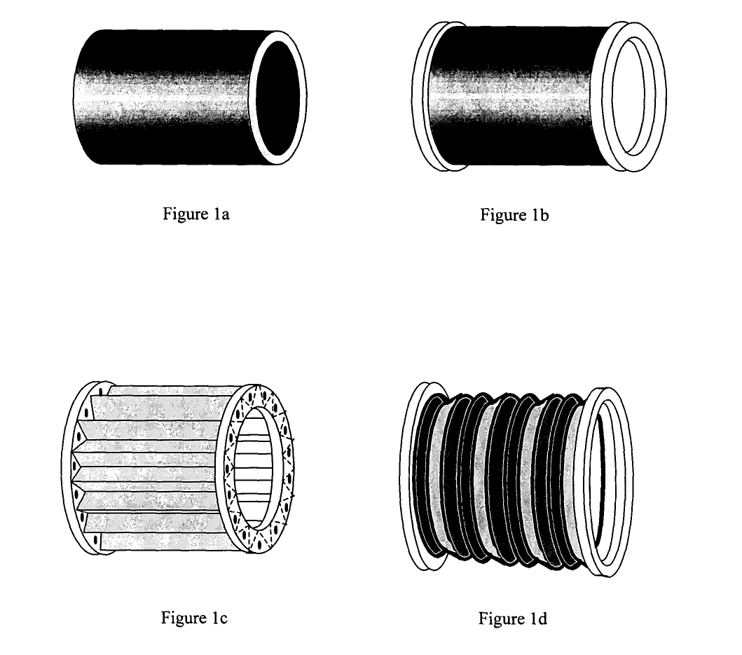

The invention element can take a variety of forms, depending upon the nature of the application and the capacity or efficiency required of the element. In one preferred embodiment, the element may be an open cylinder (FIG. 1a) that may be extruded or formed (e.g., activated carbon or zeolite and ceramic, and activated carbon or zeolite and plastic).

In another preferred embodiment, the element may be an open cylinder formed by a carbon containing sheet (carbon containing cloth or paper) wrapped into a cylinder and possibly supported on or both ends by plastic, rubber, metal, or foam supports (FIG. 1b).

In an additional preferred embodiment, the element may consist of a pleated, open cylinder possibly supported on one or both ends by plastic, rubber, metal, or foam supports (FIG. 1c). The pleated material would be made of a carbon-containing cloth or paper. If the pleated cylinder contains end supports, passages in which air may pass by the outside surface of the cylinder may be included to increase the ability of the to purge.

Also, in another preferred embodiment, the element may be corrugated and flexible to allow it to conform to a flexible or non-straight (including angular or curved) piece of ductwork (FIG. 1d). A screen, grid, or ribbing may be added to the inside surface to provide for light, localized turbulence along the surface during purging to aid in purge performance. Possibilities for coating ductwork or AIS components include attaching carbon directly to the inside of the ductwork or lining with a carbon containing cloth or paper. In any of the aforesaid embodiments that may include cloth or paper, it is appreciated that a paper may include natural fibers and synthetic fibers, including but not limited to polypropylene, nylon, and polyethylene. The containing element may be comprised of from 5-95% (preferably 10-90%) and from 95-5% (preferably 90-10%) of the support material.

The efficiency of this novel system for adsorbing hydrocarbons depends upon the inside diameter to length ratio of the element or coating, which in turn may relate to the relative ratios of adsorbent material to support material, or total mass of adsorbent material to total mass of support material. Testing has been performed to develop preliminary relationships. The adsorption efficiency of the tested invention device is related to the rate of mass transfer from the gas/vapor phase to the surface of the carbon. The invention element must be of suitable length (for a specified diameter) to adsorb the target quantity of hydrocarbons.

### EXAMPLE 1

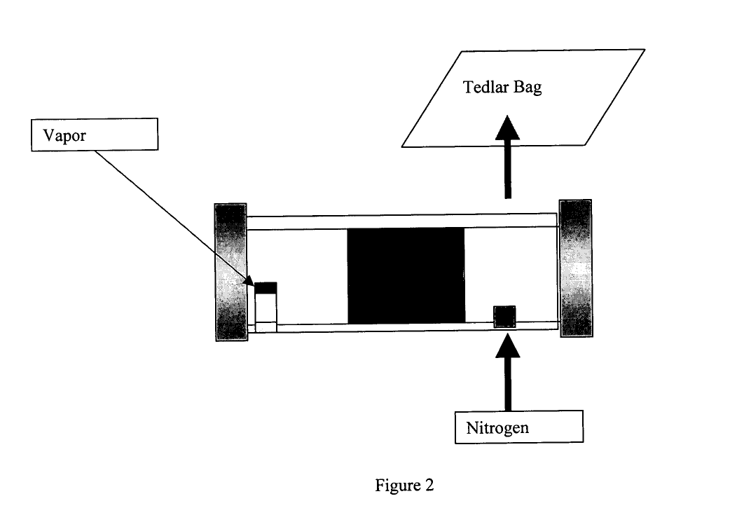

Several three-inch outside diameter carbon and ceramic open cylinders were manufactured with three different inside diameters: (1) 2.5 inch, (2) 2 inch, and (3) 1 inch, each with lengths both of one-inch and two-inch. The cylinders were each sealed in a closed cylinder (see FIG. 2), such that a load of 300 mg/d of gasoline was permitted on one side/end of the cylinder, and the emissions were measured on the opposite side/end of the carbon cylinder. Carbon cylinder evaluation data was gathered by tracking emissions for three days. The data is shown in Table I.

TABLE I

| Cylinder | Cylinder | | | | | | | | |
|---|---|---|---|---|---|---|---|---|---|
| Outside | Inside | Cylinder | Diameter/ | Day 1 | Day 1 | Day 2 | Day 2 | Day 3 | Day 3 |
| Diameter | Diameter | Length | Length | Load | Emissions | Load | Emissions | Load | Emissions |
| (inch) | (inch) | (inch) | Ratio | (mg) | (mg) | (mg) | (mg) | (mg) | (mg) |
| Blank | Blank | Blank | Blank | 324 | 375 | 312 | 288 | 272 | 313 |
| 3 | 1 | 1 | 1 | 374 | 1.7 | 266 | 8.2 | 315 | 12.8 |
| 3 | 2 | 1 | 2 | 306 | 14.2 | 332 | 34.5 | 329 | 53.2 |
| 3 | 2.5 | 1 | 2.5 | 344 | 29.5 | 335 | 77.8 | 325 | 103.7 |
| 3 | 1 | 2 | 0.5 | 337 | 3.3 | 327 | 4.8 | 313 | 7.8 |
| 3 | 2 | 2 | 1 | 322 | 3.3 | 322 | 6.8 | 331 | 12.7 |
| 3 | 2.5 | 2 | 1.25 | 327 | 8.5 | 313 | 23.3 | 322 | 35.7 |
| 3 | 1 | 2 | 0.5 | 334 | 0 | 317 | 0.2 | 324 | 0 |
| 3 | 2 | 2 | 1 | 312 | 0.17 | 317 | 0.2 | 292 | 0.8 |
| 3 | 2.5 | 2 | 1.25 | 333 | 6.2 | 324 | 10.5 | 314 | 23.8 |

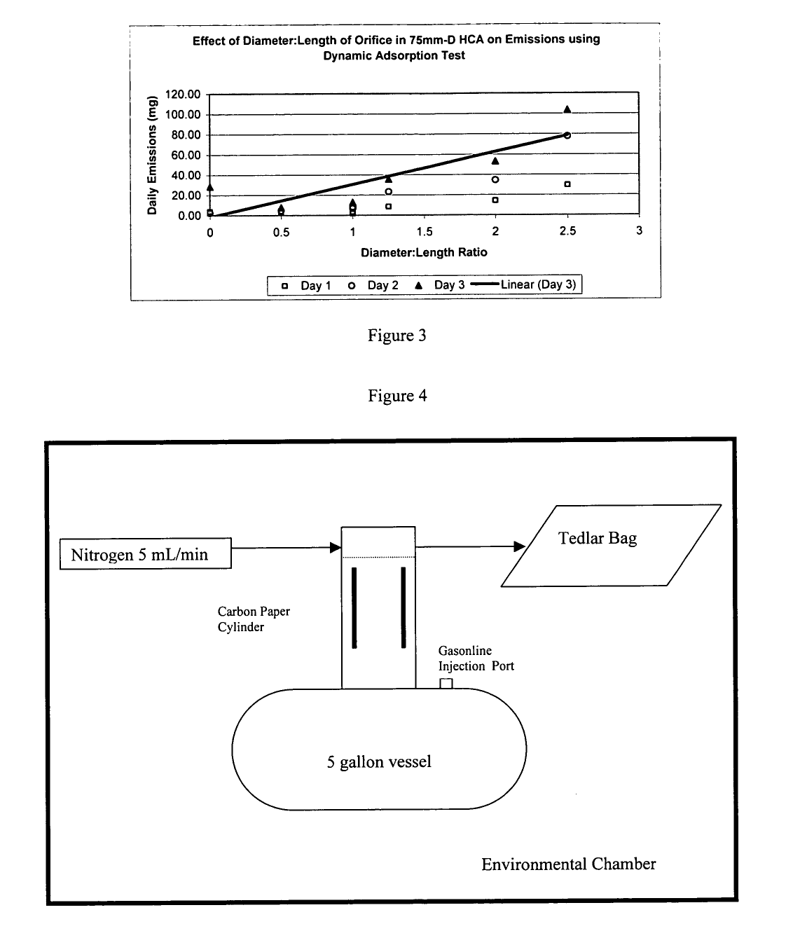

A correlation between day 3 emissions and the inside diameter to length ratio of the cylinder was made and is shown in FIG. 3. As the diameter to length ratio decreases, the amount of hydrocarbons diffusing through the element decreases.

### EXAMPLE 2

A carbon paper cylinder (paper basis weight of 270 lbs fiber/3000 ft² and 135 lbs activated carbon/3000 ft², with polypropylene and latex as binder) and a rigid carbon cylinder (80% carbon) were prepared (to form cylinders with 2.25″ I.D. and 5″ in length) and tested for performance. Each cylinder was exposed repeatedly (three cycles) to gasoline at 45 mg/min loading to 30 mg breakthrough and purged at 300 scfm for 30 minutes in a preconditioning step, then placed in the test fixture represented by FIG. 2. The test fixture was placed in an environmental chamber that underwent 24-hour temperature cycling of 65° F. to 105° F. to 65° F. A 1.5 gram gasoline injection was administered for each, and the emissions were monitored for three days. The results of this comparison between cylinder types is shown in Table II.

TABLE II

| Emission | | | |
|---|---|---|---|
| Sample taken (mg) | Blank | Hollow Cylinder | Paper Cylinder |
| Day 1 | 123 | 20 | 25 |
| Day 2 | 93.3 | 34 | 29 |
| Day 3 | 66 | 36 | 20 |

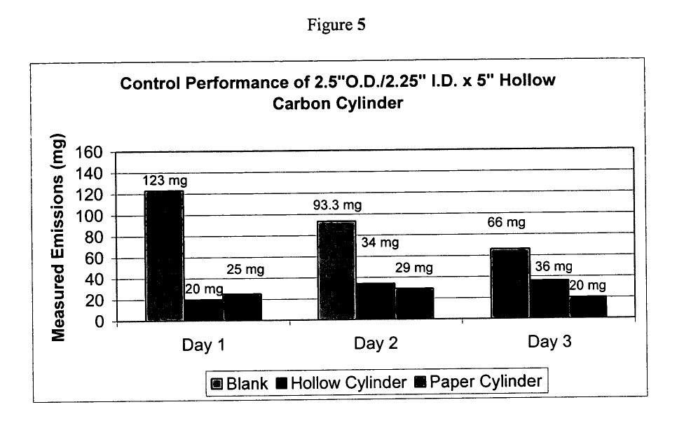

The data of Table II is graphically represented in the bar graphs of FIG. 5. Both hollow and paper cylinders showed significant emission reduction capability.

While the invention has been described above with reference to specific embodiments thereof, it will be apparent to skilled persons that minor changes, modifications, and variations may be made to the details of the invention described herein without departing from the underlying principles of the inventive concept disclosed, including various obvious substitutions, such as substitute pH-modifying acids and/or bases. Nevertheless, the subject matter of the invention is within the bounds of the following claims.

What is claimed is:

1. A shaped article for reducing hydrocarbon emissions from automotive air induction systems by adsorbing said emissions from a fluid stream passing through the air induction system, said shaped article comprising a support component and an adsorbent component and wherein said shaped article permits relatively unobstructed fluid flow therethrough.

2. The shaped article of claim 1 wherein the support component is selected from the group consisting of polymers, resins, and fibers.

3. The shaped article of claim 2 wherein the fiber component is selected from the group of fibers consisting of synthetic fibers and natural fibers.

4. The shaped article of claim 1 further comprising a binding material.

5. The shaped article of claim 1 wherein the adsorbent component is selected from the group of materials consisting of activated carbon, silica gel, and zeolite,

6. A shaped article formed by coating automotive air induction system components and related ductwork with material formed of an adhesive component and an adsorbent component for reducing hydrocarbon emissions from automotive air induction systems by adsorbing said emissions from a fluid stream passing through the air induction system, wherein said shaped article permits relatively unobstructed fluid flow therethrough, resulting in a pressure drop below a value of 1″ water column.
